(19) United States
(12) Patent Application Publication
(10) Pub. No.: US 2017/0242589 A1
(43) Pub. Date: Aug. 24, 2017

(54) MEMORY CONTROLLER, STORAGE DEVICE, INFORMATION PROCESSING SYSTEM, AND MEMORY CONTROLLING METHOD

(71) Applicant: SONY CORPORATION, TOKYO (JP)

(72) Inventor: TAKAHIRO IKARASHI, KANAGAWA (JP)

(21) Appl. No.: 15/519,465

(22) PCT Filed: Oct. 6, 2015
(86) PCT No.: PCT/JP2015/078266

§ 371 Date: Apr. 14, 2017

(30) Foreign Application Priority Data
Oct. 24, 2014 (JP) 2014-216767

(51) Int. Cl. G06F 3/06

(52) U.S. Cl. CPC G06F 3/064; G06F 3/061; G06F 3/0647; G06F 3/0683

(57) ABSTRACT

To shorten data reading time taken with respect to a memory. A selection unit selects, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory. A read control unit performs reading from one of the first memory and the second memory on the basis of a result of the selection.

### TECHNICAL FIELD

The present technology relates to a memory controller. Specifically, the technology relates to a memory controller that commands a memory performing data transfer in units of blocks at the time of writing and reading, a storage device, an information processing system, a processing method thereof, and a program for causing a computer to execute the method.

### BACKGROUND ART

Synchronous dynamic random access memories (SDRAMs) with a large capacity and a broad bandwidth have been used as memories for image memories of imaging devices and the like from the past. In order to access such an SDRAM, it is necessary to input a row address and then a column address to the SDRAM. Then, data transfer accompanying the access is performed through burst transfer. This is a scheme in which a plurality of pieces of data having consecutive column addresses are sequentially transferred, and also a scheme in which data of a pre-set number of words (a burst length) is transferred through one input of a column address. Since the transfer of the plurality of pieces of data is enabled through one input of the column addresses, a data transfer rate can be increased. Such an SDRAM has a recording area divided into blocks of a size equivalent to the burst length, and thus data is transferred in units of blocks.

An example in which data is read from an SDRAM whose burst length is set to 8 words will be described. When reading of 1-burst data is attempted by inputting #0x0 to the SDRAM as a column address, pieces of read data corresponding to column addresses #0x0 to #0x7 are sequentially output from the SDRAM. That is, pieces of data in a range expressed with the low-order three bits of the input column address (8 words) are output. When #0x8 is input as a column address, pieces of data corresponding to column addresses #0x8 to #0xF are output. A master that uses such an SDRAM as an image memory exchanges data having a size that is a multiple of a burst length with the SDRAM.

However, there are cases in which a range of data to be read by a master does not match a range of divided blocks. For example, there is a case in which a master has to read 8-word data of column addresses #0x4 to #0xB. Such reading is necessary when image data corresponding to macroblocks, which are rectangular areas set in image data, is read from an image memory to perform encoding in a Moving Picture Experts Group (MPEG) format or the like. In that case, pieces of data corresponding to column addresses #0x0 to #0x7 are output from an SDRAM even though #0x4 has been input as a column address, and thus the reading of all of the desired data fails. In order to read the data, reading with inputs of column addresses #0x0 and #0x8 twice is necessary, which causes reading time to increase.

As a method for reducing data reading time of data having a range that does not match a range divided into blocks, the following system has been proposed (for example, refer to Patent Literature 1). The proposal is about a system constituted by a master, a memory controller, and a memory in which the memory controller processes a read request from the master and generates byte combination information from address of a read destination, and then performs reading on the basis of the information. The byte combination information is information indicating a range of data to be read. To apply the above-described example, information indicating that data in an area whose address is deviated 4 words from the column address #0x0 is a read target corresponds to the byte combination information and is generated by the memory controller. The generated byte combination information is interpreted by the memory, and data in the range of addresses #0x4 to #0xB is output as read data with respect to the input column address #0x0.

### CITATION LIST

### Patent Literature

Patent Literature 1: JP 2008-159131A

### DISCLOSURE OF INVENTION

### Technical Problem

The above-described past technology has a problem that a special memory having a function of interpreting byte combination information generated by a memory controller and reading and outputting data recorded in different blocks is necessary.

The present technology has been created taking the above circumstance into consideration, and aims to shorten data reading time taken with respect to a memory, without using a special memory.

### Solution to Problem

The present technology has been made in order to solve the above problem. A first aspect of the present technology is a memory controller including: a selection unit configured to select, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory; and a read control unit configured to perform reading from one of the first memory and the second memory on the basis of a result of the selection. Accordingly, an effect that one of the first memory and the second memory is selected as the read target on the basis of the number of the blocks necessary for reading data is exhibited.

In the first aspect, a write control unit configured to perform writing of the plurality of pieces of recording data from the head of the recording start block of the first memory, generate new recording data by adding predetermined data to the head and tail of the plurality of pieces of recording data, and then write the new recording data from the head of the recording start block of the second memory may be further included. Accordingly, an effect that the plurality of pieces of data are written from the head of the recording start block of the first memory and the plurality of pieces of data are written from the middle of the recording start block of the second memory is exhibited.

In the first aspect, the first memory and the second memory may be memories that perform burst transfer at the time of writing and reading, the data may be word data, and the block size may be a burst length in the burst transfer. Accordingly, an effect that one of the first memory and the second memory is selected as the read target on the basis of the number of the blocks necessary for reading the data among the first memory and the second memory having the recording areas divided by the burst length is exhibited.

In the first aspect, the data may be bit data, the block size may be a word size constituted by a plurality of pieces of bit data, and the block may be a word. Accordingly, an effect that one of the first memory and the second memory is selected as the read target on the basis of the number of the blocks necessary for reading the data among the first memory and the second memory having the recording areas divided by the word size is exhibited.

A second aspect of the present technology is a storage device including: a first memory to which access is made in units of blocks that are recording areas divided by a block size constituted by a plurality of pieces of data and in which a plurality of pieces of recording data are recorded from the head of a recording start block; a second memory to which access is made in units of the blocks and in which the plurality of pieces of recording data are recorded from the middle of the recording start block; a selection unit configured to select one of the first memory and the second memory as a read target on the basis of the number of the blocks necessary for reading data included in the recording data recorded in the first memory or the second memory; and a read control unit configured to perform reading from one of the first memory and the second memory on the basis of a result of the selection. Accordingly, an effect that one of the first memory and the second memory is selected as the read target on the basis of the number of blocks necessary for reading the data is exhibited.

A third aspect of the present technology is an information processing system including: a storage device including a first memory to which access is made in units of blocks that are recording areas divided by a block size constituted by a plurality of pieces of data and in which a plurality of pieces of recording data are recorded from the head of a recording start block, a second memory to which access is made in units of the blocks and in which the plurality of pieces of recording data are recorded from the middle of the recording start block, a selection unit configured to select one of the first memory and the second memory as a read target on the basis of the number of the blocks necessary for reading data included in the recording data recorded in the first memory or the second memory, and a read control unit configured to perform reading from one of the first memory and the second memory on the basis of a result of the selection; and a master configured to access the data of the storage device. Accordingly, an effect that one of the first memory and the second memory is selected as the read target on the basis of the number of blocks necessary for reading the data is exhibited.

A fourth aspect of the present technology is a memory controlling method including: a selection procedure of selecting, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory; and a read control procedure of performing reading from one of the first memory and the second memory on the basis of a result of the selection. Accordingly, an effect that one of the first memory and the second memory is selected as the read target on the basis of the number of blocks necessary for reading the data is exhibited.

### Advantageous Effects of Invention

According to the present technology, an excellent effect of shortening data reading time can be exhibited without using a special memory even when data of a range that does not match a range divided into blocks is read. Note that effects described herein are not necessarily limitative, and any effect described in the present disclosure may be exhibited.

### BRIEF DESCRIPTION OF DRAWINGS

FIG. 1 is a diagram illustrating an example of a configuration of an information processing system according to an embodiment of the present technology.

FIG. 2 is a diagram illustrating an example of a configuration of a memory controller 210 according to a first embodiment of the present technology.

FIG. 3 is a diagram illustrating data writing according to the first embodiment of the present technology.

FIG. 4 is a diagram illustrating data reading according to the first embodiment of the present technology.

FIG. 5 is a diagram illustrating an example of a procedure of a write process according to the first embodiment of the present technology.

FIG. 6 is a diagram illustrating an example of a procedure of a read process according to the first embodiment of the present technology.

FIG. 7 is a diagram illustrating an example of a procedure of a memory selection process (Step S960) according to the first embodiment of the present technology.

FIG. 8 is a diagram illustrating data writing according to a second embodiment of the present technology.

FIG. 9 is a diagram illustrating data reading according to the second embodiment of the present technology.

FIG. 10 is a diagram illustrating an example of configurations of image memories according to a third embodiment of the present technology.

### MODE(S) FOR CARRYING OUT THE INVENTION

Embodiments for implementing the present technology (hereinafter referred to as embodiments) will be described below. Description will be provided in the following order.
1. First embodiment (Example of application to SDRAM)
2. Second embodiment (Example of application to SRAM)
3. Third embodiment (Example of application to image memory device)

### 1. First Embodiment

### [Configuration of Information Processing System]

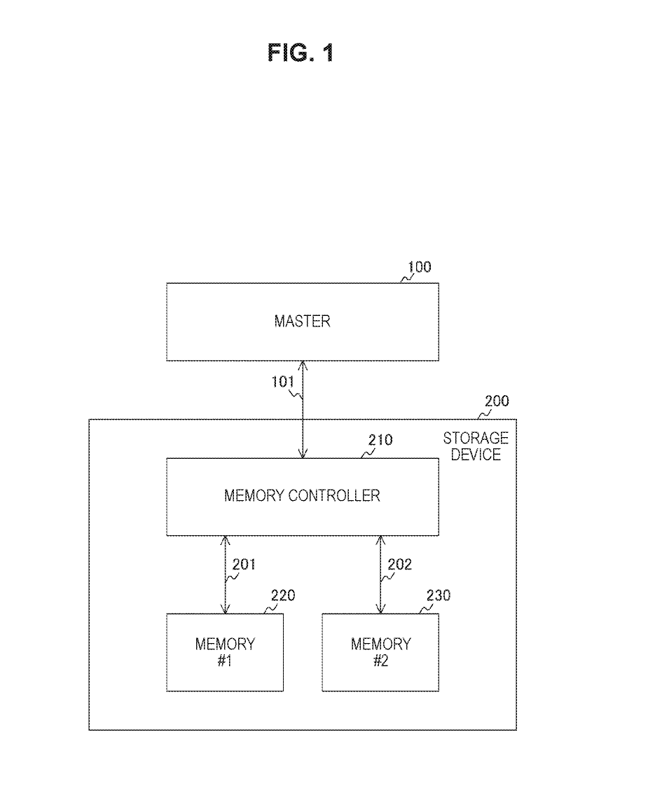

FIG. 1 is a diagram illustrating an example of a configuration of an information processing system according to an embodiment of the present technology. The information processing system of the diagram includes a master 100 and a storage device 200.

The master 100 performs processes such as image processing. The master 100 accesses the storage device 200 by issuing a command for writing or reading. The storage device 200 records data necessary for processes of the master 100. Note that a signal line 101 electrically connects the master 100 and the storage device 200.

The storage device 200 includes a memory controller 210, a memory #1 (220), and a memory #2 (230).

The memory controller 210 controls the memory #1 (220) and the memory #2 (230). The memory controller 210 interprets write and read commands issued from the master 100 and makes write and read requests based on the commands from the memory #1 (220) and the memory #2 (230).

The memory #1 (220) and the memory #2 (230) record data. Access to the data is performed on the basis of a request made by the memory controller 210. At this time, the data is transferred between the memory controller 210 and both of the memory #1 (220) and the memory #2 (230). Recording areas of the memory #1 (220) and memory #2 (230) are divided by a block size constituted by a plurality of pieces of data, and the memory controller 210 accesses thereto in units of blocks which are the divided recording areas. Memories configured by SDRAMs can be used, for example, as the memory #1 (220) and the memory #2 (230). Note that the memory #1 (220) is an example of a first memory described in the claims. The memory #2 (230) is an example of a second memory described in the claims.

Note that a signal line 201 electrically connects the memory controller 210 and the memory #1 (220). In addition, a signal line 202 electrically connects the memory controller 210 and the memory #2 (230).

When writing is to be performed, the master 100 issues a write command, write data accompanied therewith, a write destination address, and the number of pieces of the write data to the storage device 200. The write command is processed by the memory controller 210 of the storage device 200. The memory controller 210 interprets the issued write command and makes a write request with respect to the memory #1 (220) and the memory #2 (230) on the basis of the write data accompanying the command, the write destination address, and the number of pieces of the write data. The memory #1 (220) and the memory #2 (230) perform writing on the basis of the request.

On the other hand, when reading is to be performed, the master 100 issues a read command, a read destination address accompanied therewith, and the number of pieces of read data to the storage device 200. The memory controller 210 interprets the command and makes a read request with respect to the memory #1 (220) and the memory #2 (230) on the basis of the read destination address accompanying the command and the number of pieces of read data. The memory #1 (220) and the memory #2 (230) perform reading on the basis of the request and output read data to the memory controller 210. The memory controller 210 outputs the output data to the master 100. Note that sizes of the write and read data are multiples of a burst length. Details about control over writing and reading of the memory #1 (220) and the memory #2 (230) will be described below.

### [Configuration of Memory Controller]

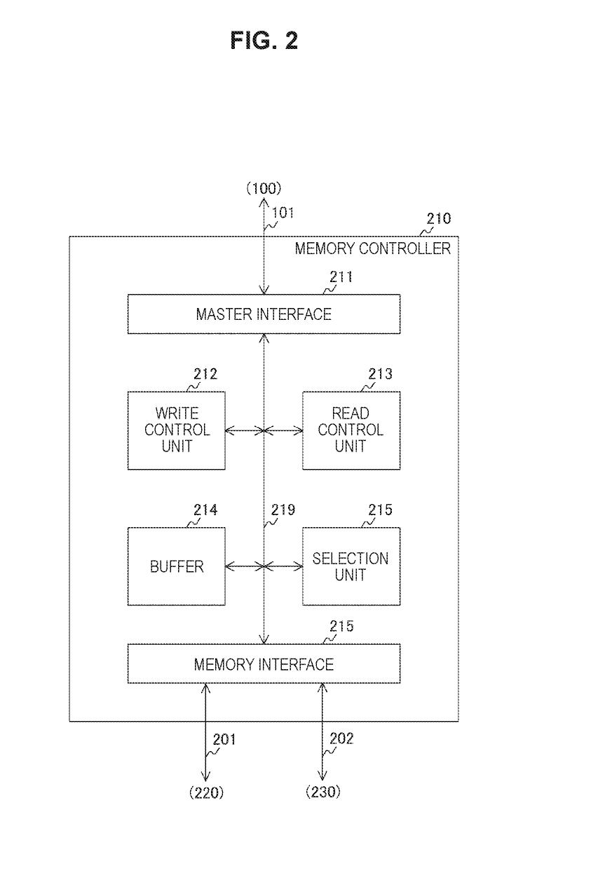

FIG. 2 is a diagram illustrating an example of a configuration of the memory controller 210 according to the first embodiment of the present technology. The memory controller 210 includes a master interface 211, a write control unit 212, a read control unit 213, a buffer 214, a selection unit 215, a memory interface 216, and a bus 219.

The maser interface 211 performs an exchange with the master 100. The memory interface 216 performs an exchange with the memory #1 (220) and the memory #2 (230).

The buffer 214 temporarily holds write and read data. The bus 219 connects units inside the memory controller 210 to each other.

The write control unit 212 controls writing of data with respect to the memory #1 (220) and the memory #2 (230). The write control unit 212 causes write data output from the master 100 and held in the buffer 214 to be transferred to and written in the memory #1 (220) and the memory #2 (230) on the basis of a write command from the master 100. Details of the data writing will be described below.

The selection unit 215 selects one of the memory #1 (220) and the memory #2 (230) for data reading. Details of a method of the selection will be described below.

The read control unit 213 reads data. The read control unit 213 reads data from the memory #1 (220) or the memory #2 (230) on the basis of a read command from the master 100. The read data is first held in the buffer 214 and then sent to the master 100. Note that the read control unit 213 performs the reading from one of the memory #1 (220) and the memory #2 (230) on the basis of a selection result of the selection unit 215.

### [Data Writing]

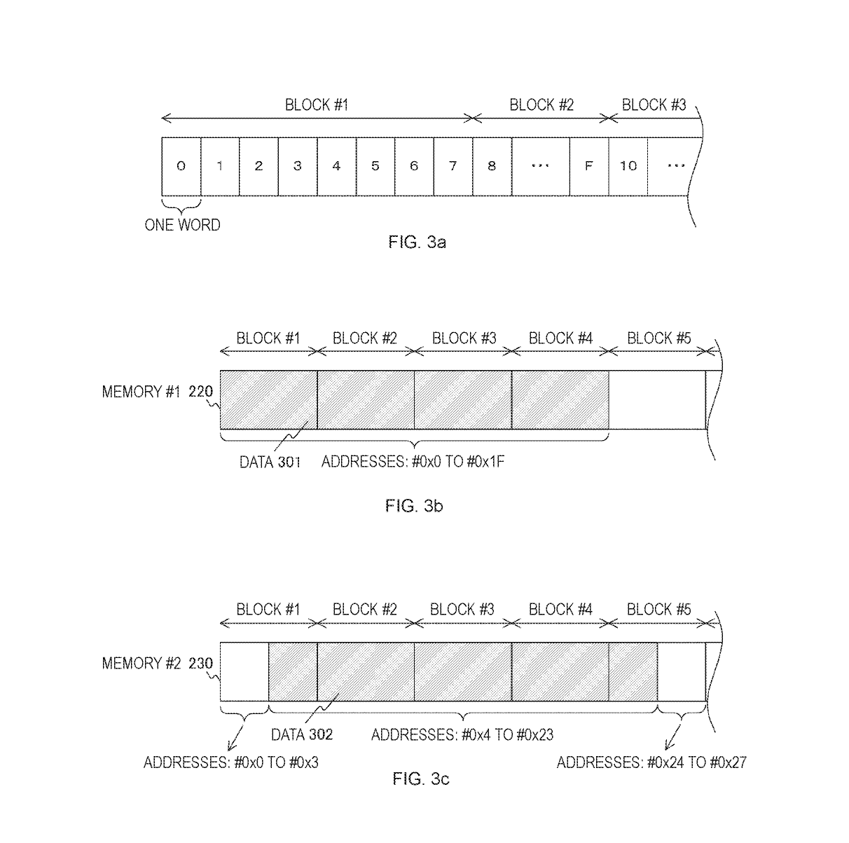

FIG. 3 is a diagram illustrating data writing according to the first embodiment of the present technology. a of the diagram illustrates a relationship between blocks and recording areas of the memory #1 (220) and the memory #2 (230). Each area compartmented by a rectangle in a of the diagram indicates an area of one word, and a letter written in the rectangular portion indicates an address of the area (indicated up to 16 bits; however, “0x” is omitted from the description due to space constraints). Note that a burst length of each of the memory #1 (220) and the memory #2 (230) is assumed to be 8 words. In this case, a block size is 8 words as well. In addition, 1 word can be set as, for example, 8-bit data. Data is recorded in the memory #1 (220) and the memory #2 (230) configured as above. Data to be recorded is called recording data.

b of the diagram illustrates a state in which 4-burst data 301, which is recording data, is recorded in the memory #1 (220). The data 301 is recorded in an area of 4 blocks having a block #1 of the memory #1 (220) as a recording start block and a block #4 as a recording end block. In addition, the data 301 is recorded from an area of an address 0x0 that belongs to the block #1. That is, the data is recorded from a head of the recording start block. On the other hand, c of the diagram illustrates a state in which 4-burst data 302, which is recording data, is recorded in the memory #2 (230). The data 302 is data having the same content as the data 301 and is recorded in an area of five blocks having a block #1 of the memory #2 (230) as a recording start block and a block #5 as a recording end block. In addition, the data 302 is recorded from an area of an address 0x4 that belongs to the block #1. That is, the data 302 is recorded from the middle of the recording start block.

In the first embodiment of the present technology, the recording data is recorded from the head of the recording start block in the memory #1 (220), and the recording data having the same content is recorded from the middle of the recording start block in the memory #2 (230) as described above. That is, the data is multiplexed due to recording of lengthy data, and the data is recorded in an area that is deviated from a block align start position in the memory #2 (230). The data recording is executed through data writing by the write control unit 212. The write control unit 212 writes write data at a designated address of the memory #1 (220). Thereafter, the same data is also written in the memory #2 (230).

The writing can be performed through, for example, the following procedure. First, the write control unit transfers the write data to the buffer 214 to be held therein. Next, the write control unit 212 writes the data held in the buffer 214 in the memory #1 (220). Accordingly, the data 301, which is the recording data, is recorded from the head of the recording start block of the memory #1 (220). Next, the write control unit 212 processes the write data held in the buffer 214 such that the written recording data is recorded from the middle of the recording start block. This process can be performed by adding data to the head and the tail of the write data.

An example in which the data 302 is recorded from the address #0x4 that is the recording area that is deviated 4 words from the head of the recording start block as illustrated in c of the diagram will be described. First, the write control unit 212 adds data recorded in an area of addresses #0x0 to #0x3 illustrated in c of the diagram to the head of the write data held in the buffer 214. Then, the write control unit 212 adds data recorded in an area of addresses #0x24 to #0x27 illustrated in c of the diagram to the tail of the write data held in the buffer 214. Note that it is necessary to read the data to be added from the memory #2 (230) in advance. Next, the write control unit 212 writes the write data having a size of 5 words as a result of the addition of the data in areas in the range of the block #1 to the block #5 of the memory #2 (230). Accordingly, the data 302, which is recording data, can be recorded from the middle of the block #1 that is the recording start block in the memory #2 (230).

### [Data Reading]

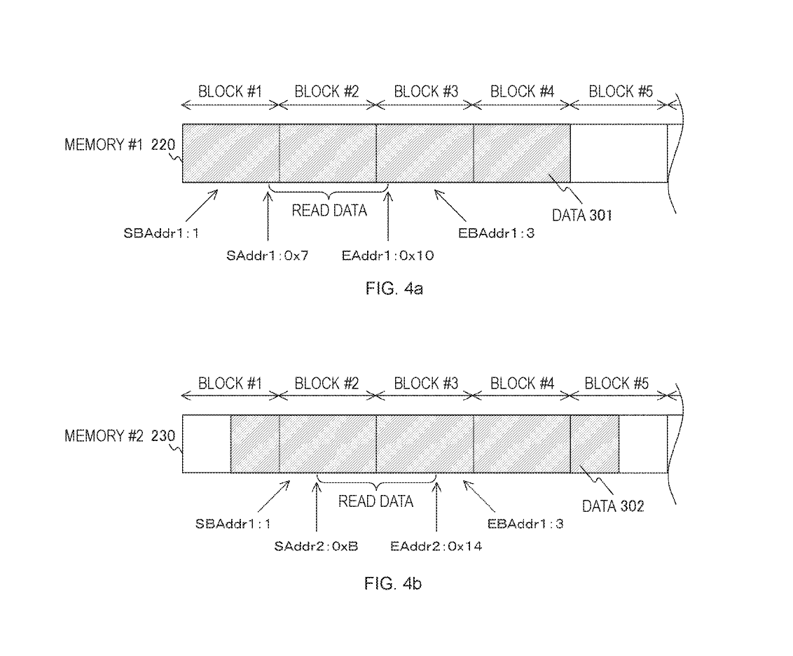

FIG. 4 is a diagram illustrating data reading according to the first embodiment of the present technology. a of the diagram illustrates a case in which partial data of the data 301 written in the memory #1 (220) is read. The data is 10-word data recorded in areas of addresses 0x7 to 0x10 and is recorded in a range that does not match the range of the divided blocks. When the data is read from the memory #1 (220), it is necessary to read data of three blocks from the block #1 to the block #3. On the other hand, b of the diagram illustrates a case in which data having the same content as the above-described data is read from the data 302 written in the memory #2 (230). The data having the same content as the data recorded in the areas of the addresses 0x7 to 0x10 of the memory #1 (220) is recorded in an area of addresses 0xB to 0x14 of the memory #2 (230). When the data is read from the memory #2 (230), the data reading may be performed at two blocks of the block #2 and the block #3. In this case, it is possible to shorten reading time more in the case of reading from the memory #2 (230) than in the case of reading from the memory #1 (220).

The selection unit 215 selects a memory for reading. A selection method will be described as follows. First, the head and tail physical addresses of areas of the memory #1 (220) in which data relating to reading is recorded are computed. As illustrated in a of the diagram, the addresses will be referred to as SAddr1 and EAddr1 hereinbelow. Since the data 301 is recorded from an area of the head block in the case of the memory #1 (220), a head address and a tail address of the desired read data coincide with the head physical address SAddr1 and the tail physical address EAddr1. Head and tail physical addresses of areas of the memory #2 (230) in which data relating to reading are likewise computed. Hereinbelow, the addresses are referred to as SAddr2 and EAddr2.

In the memory #2 (230), the data 302 is recorded from the middle of the blocks. This means that address of data relating to reading and physical addresses of areas in which the data is recorded have different values. In b of the diagram, since the data 302 is recorded from an area that is deviated 4 words from the address 0x0 of the head area of the blocks, the head physical address SAddr2 and the tail physical address EAddr2 are respectively 0xB and 0x14.

Next, positions of the blocks in which SAddr1, EAddr1, SAddr2, and EAddr2 are included are computed. As illustrated in the diagram, the positions are referred to as SBAddr1, EBAddr1, SBAddr2, and EBAddr2 hereinbelow. These can be computed on the basis of the following formulas.

SBAddr1=floor(SAddr1/8)+1

EBAddr1=floor(EAddr1/8)+1

SBAddr2=floor(SAddr2/8)+1

EBAddr2=floor(EAddr2/8)+1

Here, floor indicates an arithmetic operation of rounding down to the ones place. In the example illustrated in the diagram, values of SBAddr1, EBAddr1, SBAddr2, and EBAddr2 are respectively “1,” “3,” “2,” and “3.”

Next, the number of read blocks of the memory #1 (220) and the memory #2 (230) is computed from SBAddr1, EBAddr1, SBAddr2, and EBAddr2. The number of read blocks of the memory #1 (220) and the number of read blocks of the memory #2 (230) are respectively referred to as RB1 and RB2. These can be computed on the basis of the following formulas.

RB1=EBAddr1−SBAddr1+1

RB2=EBAddr2−SBAddr2+1

A memory having a smaller value between the number of read blocks RB1 of the memory #1 (220) and the number of read blocks RB2 of the memory #2 (230) is set as a read target memory. In the example of the diagram, the number of read blocks RB1 of the memory #1 (220) is the value “3,” and the number of read blocks RB2 of the memory #2 (230) is the value “2.” Since RB2 is smaller than RB1, the memory #2 (230) is selected as the read target memory. In this manner, a memory for reading is selected.

The read control unit 213 reads the data from the selected memory and transfers the data to the buffer 214. Then, when extra data is included in the data that has been transferred to the buffer 214, the read control unit 213 eliminates the aforementioned data. The extra data corresponds to data of 4 words from the head of the read data when, for example, reading is performed from the block #1) of the memory #2 (230). The data is the data added to the write data during the writing described in b of FIG. 3. The read control unit 213 performs the elimination of the extra data. Thereafter, the read data from which the extra data has been eliminated is sent to the master 100. Note that, when there is no problem in the master 100 performing processes even though the above-described extra data is included in the read data, this process may be omitted. Since reading is performed by selecting a memory whose number of blocks for reading is smaller as described above, time taken to read data can be shortened, and a memory band can be reduced.

### [Write Process]

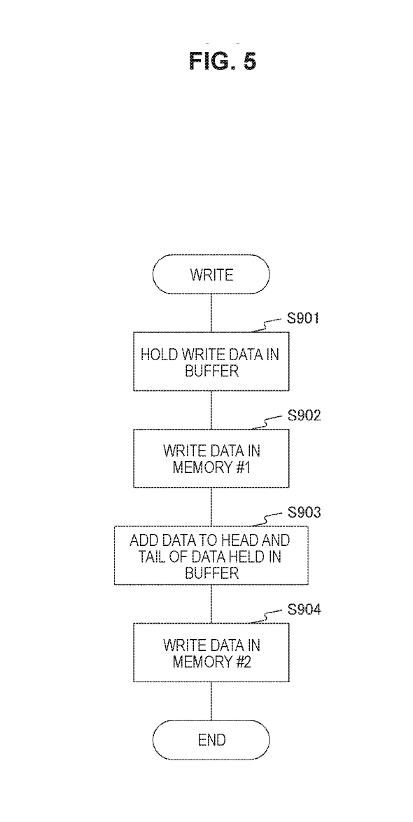

FIG. 5 is a diagram illustrating an example of a procedure of a write process according to the first embodiment of the present technology. When a write command is issued from a master, the memory controller 210 starts the process. First, the memory controller 210 causes the buffer 214 to hold write data relating to the write command (Step S901). Next, the memory controller 210 transfers the write data held in the buffer 214 to the memory #1 (220) to be written therein (Step S902). Next, the memory controller 210 adds data to the head and tail of the write data held in the buffer 214 as described above with respect to FIG. 3 (Step S903). Next, the memory controller 210 transfers the write data to which the data has been added from the buffer 214 to the memory #2 (230) to be written therein (Step S904), and then ends the write process.

### [Reading Process]

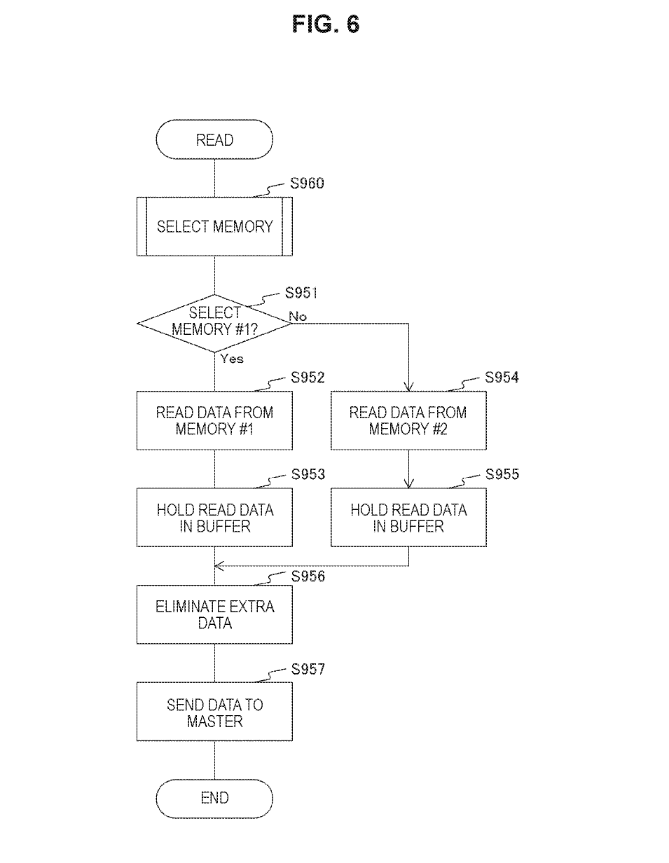

FIG. 6 is a diagram illustrating an example of a procedure of a read process according to the first embodiment of the present technology. When a read command is issued from a master, the memory controller 210 starts the process. First, the memory controller 210 selects a memory on the basis of a read destination address of the read command (Step S960). Next, the memory controller 210 performs reading on the basis of the memory selection result. When the memory #1 (220) is selected (Yes in Step S951), the memory controller 210 reads data from the memory #1 (220) (Step S952) and causes the buffer 214 to hold the read data (Step S953). Thereafter, the process proceeds to the process of Step S956.

On the other hand, when the memory #2 (230) is selected (No in Step S951), the memory controller 210 reads data from the memory #2 (230) (Step S954) and causes the buffer 214 to hold the read data (Step S955). Thereafter, the process proceeds to the process of Step S956. In Step S956, the memory controller 210 eliminates extra data from the data held in the buffer 214 (Step S956) and sends the result to the master 100 (Step S957). Then, the memory controller 210 ends the read process.

### [Memory Selection Process]

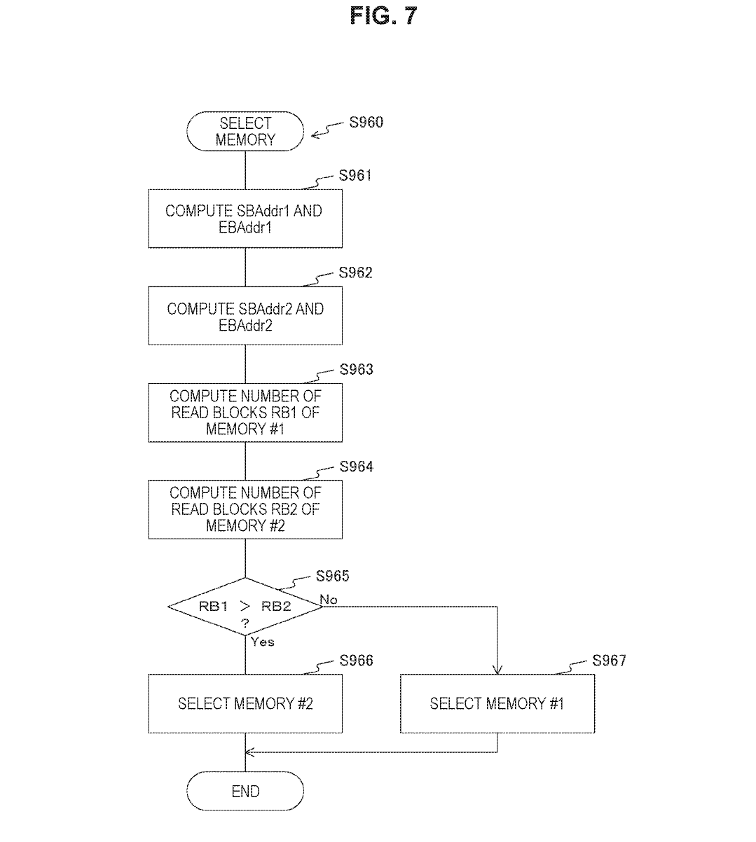

FIG. 7 is a diagram illustrating an example of a procedure of a memory selection process (Step S960) according to the first embodiment of the present technology. The memory controller 210 computes the head physical address SBAddr1 and the tail physical address EBAddr1 of areas of the memory #1 (220) in which data relating to reading is recorded (Step S961). Likewise, the memory controller 210 computes the head physical address SBAddr2 and the tail physical address EBAddr2 of areas of the memory #2 (230) in which data relating to the reading is recorded (Step S962). Next, the memory controller 210 computes the number of read blocks RB1 of the memory #1 (220) (Step S963). Likewise, the memory controller 210 computes the number of read blocks RB2 of the memory #2 (230) (Step S964).

Next, the memory controller 210 compares the number of read blocks RB1 of the memory #1 (220) to the number of read blocks RB2 of the memory #2 (230) (Step S965). When the number of read blocks RB2 of the memory #2 (230) is smaller as a result (Yes in Step S965), the memory controller 210 selects the memory #2 (230) (Step S966) and ends the selection process. On the other hand, when the number of read blocks RB2 of the memory #2 (230) is not smaller (No in Step S965), the memory controller 210 selects the memory #1 (220) (Step S967) and ends the selection process.

According to the first embodiment of the present technology, the same pieces of data are recorded in two memories configured by SDRAMs as described above. At this time, the data is recorded from the head of a recording start block of one memory, and the data is recorded from the middle of a recording start block of the other memory. Then, a memory whose number of blocks necessary for reading is smaller is selected and reading is performed, and therefore data reading time can be shortened more in a system in which SDRAMs are used.

### 2. Second Embodiment

In the above-described first embodiment, the SDRAMs whose block sizes are set to burst lengths and in which burst transfer is performed are assumed. On the other hand, in the second embodiment of the present technology, application to SRAMs is assumed. In this case, a block size corresponds to a word size, which is a data length of an SRAM. Thus, data reading time can be shortened more in a storage device in which SRAMs are used.

### [Configuration of Storage Device]

A storage device 200 according to the second embodiment of the present technology can adopt a configuration in which the memory #1 (220) and the memory #2 (230) of the storage device 200 described with respect to FIG. 1 are replaced with memories configured by SRAMs. SRAMs in a mode in which no burst transfer is performed can be used, for example, as the SRAMs. A word size of such an SRAM is assumed to be 16 bits. A block size in this case is the word size as described above. Other configurations of the storage device 200 and memory controller 210 are similar to those of the first embodiment described above, and thus description thereof will be omitted.

### [Data Writing]

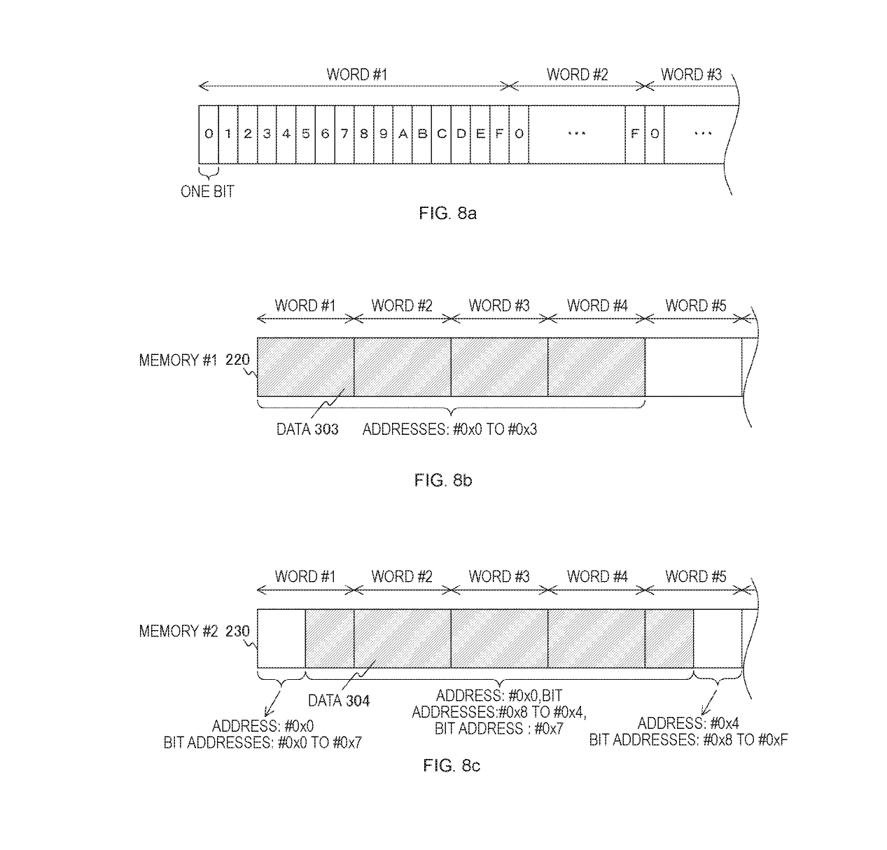

FIG. 8 is a diagram illustrating data writing according to the second embodiment of the present technology. a of the diagram illustrates a relationship between blocks (words) and recording areas of the memory #1 (220) and the memory #2 (230). Each area compartmented by a rectangle in a of the diagram indicates an area of one bit, and a letter written in the rectangular portion indicates a bit address of each bit (indicated up to 16 bits; however, “0x” is omitted from the description due to space constraints).

b of the diagram illustrates a state in which 4-word data 303, which is recording data, is recorded in the memory #1 (220). The data 303 is recorded in areas of 4 words including a word #1 of the memory #1 (220) as a recording start word and a word #4 as a recording end word thereof. In addition, the data 303 is recorded from a first bit (a bit address 0x0) of the word #1. That is, the recording is performed from the head of the recording start word. On the other hand, c of the diagram illustrates a state in which 4-word data 304, which is recording data, is recorded in the memory #2 (230). The data 304 is data having the same content as the data 303 and is recorded from the area of a bit address 0x8 that belongs to a word #1 of the memory #2 (230). That is, the recording is performed from the middle of a recording start word.

Also in the second embodiment of the present technology, the recording data is recorded from the head of the recording start word of the memory #1 (220), and the recording data having the same content is recorded from the middle of the recording start word of the memory #2 (230) as described above. The recording can be executed by the write control unit 212 through data writing, and the writing can be performed by, for example, the following procedure the same as the procedure described with respect to FIG. 3. First, the write control unit 212 causes write data to be transferred to and held in the buffer 214. Next, the write control unit 212 writes the data held in the buffer 214 in the memory #1 (220). Accordingly, the data 303, which is the recording data, is recorded from the head of the recording start word of the memory #1 (220). Next, the write control unit 212 adds bit data to the head and the tail of the write data such that the written recording data is recorded from the middle of the recording start word.

A case in which the data 304 is recorded from a bit address #0x8, which is a recording area that is deviated 8 bits from the head of the recording start word as illustrated in c of the diagram, will be described as an example. First, the write control unit 212 adds bit data recorded in areas of an address #0x0 and bit addresses #0x0 to #0x7 illustrated in c of the diagram to the head of the write data held in the buffer 214. Next, the write control unit 212 adds bit data recorded in areas of an address 0x4 and bit addresses #0x8 to #0xF illustrated in c of the diagram to the tail of the write data held in the buffer 214. Note that it is necessary to read the bit data to be added from the memory #2 (230) in advance. Next, the write control unit 212 writes write data having a size of 5 words as a result of the addition of the data in areas in the range of the word #1 to word #5 of the memory #2 (230). Accordingly, the data 302, which is the recording data, can be recorded from the middle of the word #1, which is the recording start word of the memory #2 (230).

### [Data Reading]

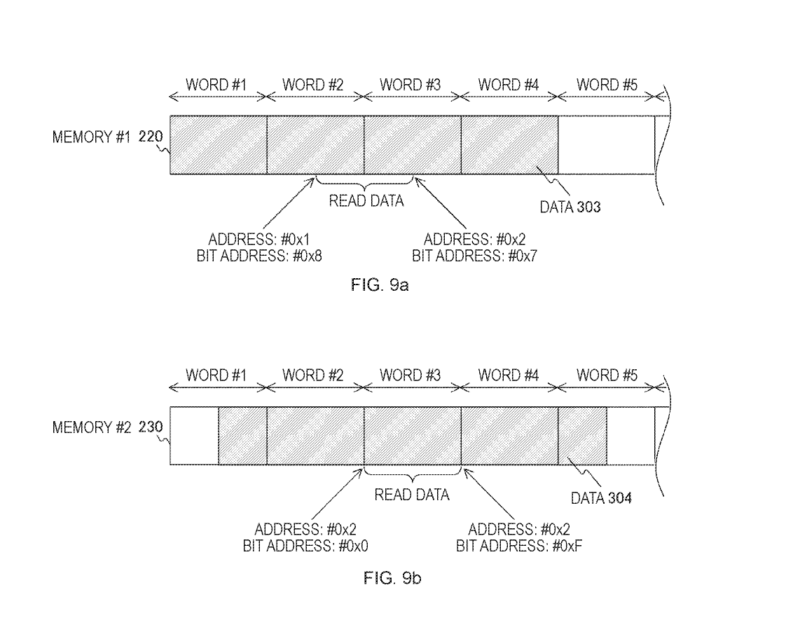

FIG. 9 is a diagram illustrating data reading according to the second embodiment of the present technology. a of the diagram illustrates a case in which partial data of the data 303 written in the memory #1 (220) is read. A case in which such reading is necessary corresponds to one in which the master 100 performs data processing in units of 8 bits, and necessary data is recorded in areas across boundaries of words in the memory #1 (220). When data recorded at an address 0x1 and a bit address 0x8 to an address 0x2 and a bit address 0x7 is read from the memory #1 (220), it is necessary to read data of 2 words that are a word #2 and a word #3. On the other hand, b of the diagram illustrates a case in which the same data as the above-described data is read from the data 304 written in the memory #2 (230). The above-described data of the memory #1 (220) is recorded in an area at a bit address 0x0 to a bit address 0xF of the word #3 of the memory #2 (230). When the data is read from the memory #2 (230), it is sufficient to read 1-word data, and thus reading time can be shortened more than when reading from the memory #1 (220).

Also in the second embodiment of the present technology, the selection unit 215 selects a memory for reading. For the selection, a similar method to the method described in the first embodiment of the present technology can be used. First, head and tail physical addresses (a word address+a bit address) of areas of the memory #1 (220) and the memory #2 (230) in which data relating to reading is recorded are computed, and positions of words that include the data are computed. Next, the numbers of read words of both the memory #1 (220) and the memory #2 (230) is computed from the computed positions of the words. Finally, a memory having a smaller computed number of read words is selected.

The read control unit 213 reads the data from the selected memory and then transfers the data to the buffer 214. Next, when there is extra data in the data transferred to the buffer 214, the extra data is eliminated. Then, the read data from which the extra data has been eliminated is sent to the master 100.

As described above, the same data is recorded in the two memories configured by SRAMs according to the second embodiment of the present technology. At that time, the data is recorded from the head of a record start block in one memory, and data is recorded from the middle of a record start block in the other memory. Then, by selecting one memory having a smaller number of words necessary for reading and then performing reading, data reading time in the system using the SRAMs can be shortened.

### 3. Third Embodiment

The storage device configured with SDRAMs is assumed in the above-described first embodiment. In the third embodiment, however, application to an image memory device is assumed. Thereby, data reading time in the image memory device can be shortened as well.

### [Configuration of Information Processing System]

An information processing system according to the third embodiment of the present technology can employ a similar configuration to that of the information processing system described with respect to FIG. 1. The memory #1 (220) and the memory #2 (230), however, are image memories in which image data is recorded and are configured by SDRAMs.

### [Configuration of Image Memory]

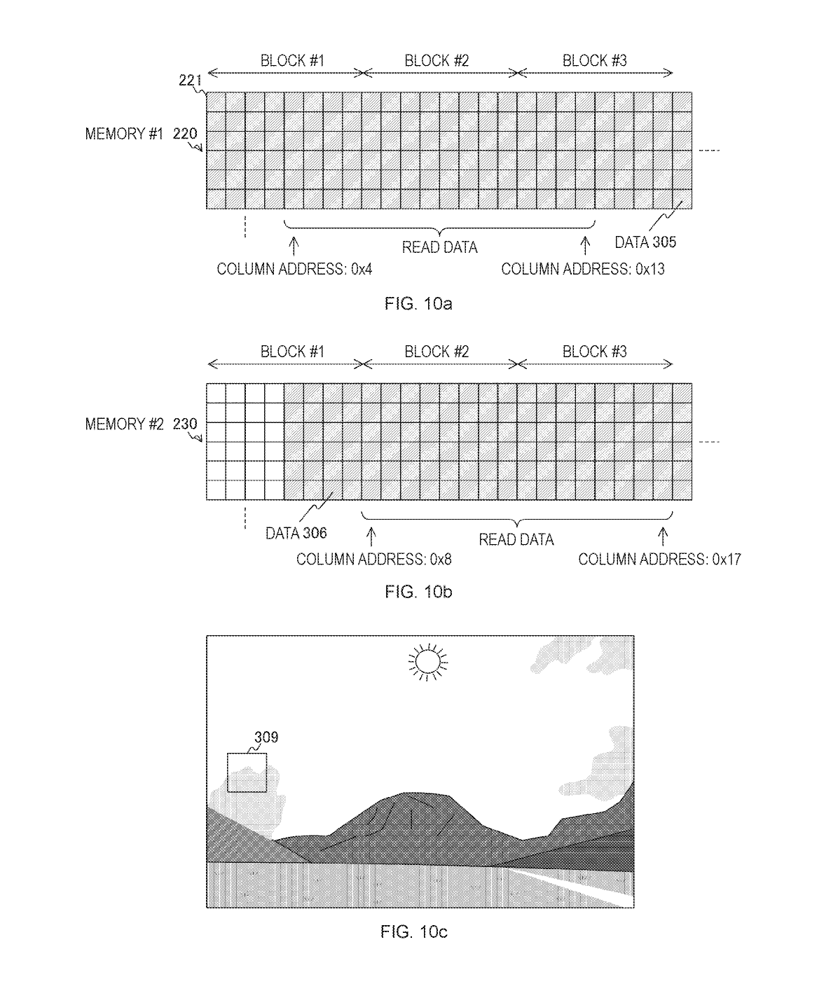

FIG. 10 is a diagram illustrating an example of configurations of image memories according to the third embodiment of the present technology. The image memories in the diagram are configured as the memory #1 (220) and the memory #2 (230), which are SDRAMs. a of the diagram and b of the diagram respectively schematically illustrate the memory #1 (220) and the memory #2 (230). Each area illustrated in a rectangle in the diagrams indicates a recording area of one word. The memory #1 (220) and the memory #2 (230) are configured to have recording areas that are arranged two-dimensionally. The horizontal direction of this two dimensional arrangement represents an array in column address order of SDRAMs, and the vertical direction thereof represents an array in row address order of the SDRAMs. Describing the memory #1 (220) as an example, a recording area 221 arranged at the upper-left of the memory #1 (220) corresponds to a recording area having the value “0” at both the column address and row address. Other recording areas are arranged in order of column addresses in the right direction of the diagram, and in order of row addresses in the downward direction of the diagram.

In addition, the memories are assumed to have burst lengths of 8 words. In a of the diagram, data 305 (a hatched area) is recorded from the head of blocks of the memory #1 (220). On the other hand, in b of the diagram, data 306 (a hatched area) having the same content as the data 305 is deviated 4 words from the head of blocks of the memory #2 and recorded (230). Note that, since a configuration of a memory controller is similar to that of the memory controller 210 described with respect to FIG. 1, description thereof will be omitted.

### [Data Reading]

A case in which image data illustrated in c of the diagram is recorded in the memory #1 (220) and the memory #2 (230) configured as above is assumed. In image processing, image data is processed mostly in units of macroblocks which are rectangular areas set in the image data. For example, when motion vector compensation is performed, there may be a case in which macroblocks 309 are set as illustrated in c of the diagram, and macroblocks including an image approximating to the aforementioned macroblocks 309 are searched for. In this case, it is necessary to read data of an image included in the macroblocks 309 from the image memory. Here, image data of one pixel is assumed to be recorded in a recording area of one word shown in a and b of the diagram. When a size of the macroblocks is set to 16×16 pixels, it is necessary to read data of 16 words at the same row address and to repeat reading for 16 row addresses. As illustrated in a of the diagram, when a range of the read data is from column addresses 0x4 to 0x13 of the memory #1 (220), it is necessary to read three blocks from a block #1 to a block #3.

Meanwhile, when data having the same content as the above-described data is read from the memory #2 (230), the data corresponds to data in a range of column addresses 0x8 to 0x17 as illustrated in b of the diagram. Since reading two blocks of a block #2 and the block #3 is sufficient for reading the data, shorter reading time is attained than when reading from the memory #1 (220). Note that, since a selection method and the like with respect to the memory #1 (220) and the memory #2 (230) are similar to those described in the first embodiment of the present technology, description thereof will be omitted.

As described above, data reading time can also be shortened in the application of the present technology to the image memory according to the third embodiment of the present technology.

According to the embodiments of the present technology, two memories, which are a memory in which data is recorded from the head of a recording start block and the other memory in which data is recorded from the middle of a recording start block, are used as described above. Among these, a memory having a smaller number of blocks necessary for reading is selected and then reading is performed. Accordingly, even when data of a range that does not match a range divided into blocks is read in a system using SDRAMs or the like, data reading time can be shortened.

The above-described embodiments are examples for embodying the present technology, and matters in the embodiments each have a corresponding relationship with disclosure-specific matters in the claims. Likewise, the matters in the embodiments and the disclosure-specific matters in the claims denoted by the same names have a corresponding relationship with each other. However, the present technology is not limited to the embodiments, and various modifications of the embodiments may be embodied in the scope of the present technology without departing from the spirit of the present technology.

The processing sequences that are described in the embodiments described above may be handled as a method having a series of sequences or may be handled as a program for causing a computer to execute the series of sequences and recording medium storing the program. As the recording medium, a CD (Compact Disc), an MD (MiniDisc), and a DVD (Digital Versatile Disk), a memory card, and a Blu-ray disc (registered trademark) can be used.

In addition, the effects described in the present specification are not limiting but are merely examples, and there may be other effects.

Additionally, the present technology may also be configured as below.

(1)

A memory controller including:

a selection unit configured to select, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory; and

a read control unit configured to perform reading from one of the first memory and the second memory on the basis of a result of the selection.

(2)

The memory controller according to (1), further including:

a write control unit configured to perform writing of the plurality of pieces of recording data from the head of the recording start block of the first memory, generate new recording data by adding predetermined data to the head and tail of the plurality of pieces of recording data, and then write the new recording data from the head of the recording start block of the second memory.

(3)

The memory controller according to (1) or (2),

wherein the first memory and the second memory are memories that perform burst transfer at the time of writing and reading,

the data is word data, and

the block size is a burst length in the burst transfer.

(4)

The memory controller according to (1) or (2),

wherein the data is bit data,

the block size is a word size constituted by a plurality of pieces of bit data, and

the block is a word.

(5)

A storage device including:

a first memory to which access is made in units of blocks that are recording areas divided by a block size constituted by a plurality of pieces of data and in which a plurality of pieces of recording data are recorded from the head of a recording start block;

a second memory to which access is made in units of the blocks and in which the plurality of pieces of recording data are recorded from the middle of the recording start block;

a selection unit configured to select one of the first memory and the second memory as a read target on the basis of the number of the blocks necessary for reading data included in the recording data recorded in the first memory or the second memory; and

a read control unit configured to perform reading from one of the first memory and the second memory on the basis of a result of the selection.

(6)

An information processing system including:

a storage device including
a first memory to which access is made in units of blocks that are recording areas divided by a block size constituted by a plurality of pieces of data and in which a plurality of pieces of recording data are recorded from the head of a recording start block,
a second memory to which access is made in units of the blocks and in which the plurality of pieces of recording data are recorded from the middle of the recording start block,
a selection unit configured to select one of the first memory and the second memory as a read target on the basis of the number of the blocks necessary for reading data included in the recording data recorded in the first memory or the second memory, and
a read control unit configured to perform reading from one of the first memory and the second memory on the basis of a result of the selection; and

a master configured to access the data of the storage device.

(7)

A memory controlling method including:

a selection procedure of selecting, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory; and

a read control procedure of performing reading from one of the first memory and the second memory on the basis of a result of the selection.

### REFERENCE SIGNS LIST

100 master
200 storage device
210 memory controller
211 mater interface
212 write control unit
213 read control unit
214 buffer
215 selection unit
216 memory interface
220 memory #1
230 memory #2
309 macroblock

1. A memory controller comprising:
a selection unit configured to select, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory; and
a read control unit configured to perform reading from one of the first memory and the second memory on the basis of a result of the selection.

2. The memory controller according to claim 1, further comprising:
a write control unit configured to perform writing of the plurality of pieces of recording data from the head of the recording start block of the first memory, generate new recording data by adding predetermined data to the head and tail of the plurality of pieces of recording data, and then write the new recording data from the head of the recording start block of the second memory.

3. The memory controller according to claim 1,
wherein the first memory and the second memory are memories that perform burst transfer at the time of writing and reading,
the data is word data, and
the block size is a burst length in the burst transfer.

4. The memory controller according to claim 1,
wherein the data is bit data,
the block size is a word size constituted by a plurality of pieces of bit data, and
the block is a word.

5. A storage device comprising:
a first memory to which access is made in units of blocks that are recording areas divided by a block size constituted by a plurality of pieces of data and in which a plurality of pieces of recording data are recorded from the head of a recording start block;
a second memory to which access is made in units of the blocks and in which the plurality of pieces of recording data are recorded from the middle of the recording start block;
a selection unit configured to select one of the first memory and the second memory as a read target on the basis of the number of the blocks necessary for reading data included in the recording data recorded in the first memory or the second memory; and
a read control unit configured to perform reading from one of the first memory and the second memory on the basis of a result of the selection.

6. An information processing system comprising:
a storage device including
a first memory to which access is made in units of blocks that are recording areas divided by a block size constituted by a plurality of pieces of data and in which a plurality of pieces of recording data are recorded from the head of a recording start block,
a second memory to which access is made in units of the blocks and in which the plurality of pieces of recording data are recorded from the middle of the recording start block,
a selection unit configured to select one of the first memory and the second memory as a read target on the basis of the number of the blocks necessary for reading data included in the recording data recorded in the first memory or the second memory, and
a read control unit configured to perform reading from one of the first memory and the second memory on the basis of a result of the selection; and
a master configured to access the data of the storage device.

7. A memory controlling method comprising:
a selection procedure of selecting, with respect to a first memory to which access is made in units of blocks that are recording areas divided by a block size constituted by a plurality of pieces of data and in which a plurality of pieces of recording data are recorded from the head of a recording start block, and a second memory to which access is made in units of the blocks and in which the plurality of pieces of recording data are recorded from the middle of the recording start block, one of the first memory and the second memory as a read target on the basis of the number of the blocks necessary for reading data included in the recording data recorded in the first memory or the second memory; and
a read control procedure of performing reading from one of the first memory and the second memory on the basis of a result of the selection.
